(19) United States
(12) Patent Application Publication
(10) Pub. No.: US 2024/0293780 A1
(43) Pub. Date: Sep. 5, 2024

(54) FLOW PATH MATERIAL FOR LIQUID SEPARATION DEVICES

(71) Applicant: KB SEIREN, LTD., Fukui (JP)

(72) Inventor: Masahiro MATSUNAGA, Fukui (JP)

(73) Assignee: KB SEIREN, LTD., Fukui (JP)

(21) Appl. No.: 18/576,477

(22) PCT Filed: Jul. 8, 2021
(86) PCT No.: PCT/JP2021/025851

§ 371 Date: Jan. 4, 2024

(51) Int. Cl. B01D 63/10; B01D 71/14; D04B 21/08; D04B 21/20

(52) U.S. Cl. CPC B01D 63/107; B01D 71/14; D04B 21/08; D04B 21/20; B01D 2313/146; D10B 2331/04; D10B 2505/04

(57) ABSTRACT

Provided is a flow path material for a liquid separation apparatus, which is less likely to collapse upon the application of a high pressure to the flow path material and causes a lower reduction of the flow rate. The flow path material for a liquid separation apparatus includes a tricot fabric containing thermoplastic core-sheath composite fibers each made of two kinds of polyester resins having different melting points or softening points. The flow path material for a liquid separation apparatus is configured such that: in the thermoplastic core-sheath composite fibers, a high-melting-point component is placed in the core, while a low-melting-point component is placed in the sheath; the tricot fabric is a tricot knitted fabric knitted with a two-guide-reed knitting machine using the thermoplastic core-sheath composite fibers as a front yarn and a back yarn and is rigidified by the thermoplastic core-sheath composite fibers being bonded to each other; the tricot fabric has a wale density of 45 to 70 yarns/inch (2.54 cm) and a course density of 40 to 70 yarns/inch (2.54 cm); and, when the tricot fabric is heat-pressed at 90° C. and 4.0 MPa for 3 minutes, the percentage of change in the thickness of the tricot fabric before and after pressing is 10% or less.

### TECHNICAL FIELD

The present invention relates to a flow path material for a liquid separation apparatus, which supports, in a liquid separation apparatus used for concentrating or separating various liquids, the back side of a semipermeable membrane that receives the pressure from a raw liquid.

### BACKGROUND ART

A liquid separation apparatus utilizing a semipermeable membrane typically uses a spiral-type liquid separation membrane module, in which, generally, the semipermeable membrane is formed into a cylindrical shape, then a flow path material is inserted therein to serve as a flow path when a pressure is applied from the outer side of the membrane to allow a penetrant to flow on the inner side of the membrane, and the flow path material is fixed at its end to a hollow shaft and wound thereon. In such a liquid separation membrane module, a high-pressure raw liquid equal to or higher than reverse osmosis pressure is passed on the outer side of the membrane, and a permeated liquid that has passed through the membrane flows on the inner side of the membrane and is taken out. Since the cylindrical separation membrane is pressurized from the outer side with a high pressure, the flow path material inserted as a flow path for a permeated liquid may collapse, impairing the flow of the liquid. Thus, in order to prevent the flow path material from collapsing even when pressurized from the outer side to the inner side of the separation membrane, the flow path material itself is rigidified to withstand deformation. Such liquid separation membrane modules have been put into practical use for the pretreatment of boiler water, the reuse of wastewater, and the desalination of seawater, and also as ultrapure water generators, etc.

Conventionally, as such flow path materials for permeated water, fabrics such as woven fabrics and knitted fabrics have been used, and particularly those structured to have fine grooves on the surface have been used. These fabrics have been impregnated with an epoxy resin, a melamine resin, or the like and rigidified in order to prevent deformation due to the pressure applied to the raw liquid through the membrane. In that case, in order to prevent a fabric from collapsing even at a high pressure, it has been necessary to apply a resin to nearly half the weight of the fabric. However, in applications that require high-purity permeated water or applications that treat high-temperature liquids, there has been a problem due to the elution of the impregnating resin. In particular, in the case where the raw liquid to be treated is a liquid for food or a liquid for medical use, being sterile is required. Therefore, in order to prevent bacterial contamination, sterilization with hot water is performed before the start of or after the completion of the membrane separation treatment, and the elution of the resin impregnating the flow path material at that time has thus been a problem.

In order to solve the above problem, a flow path material configured as follows has been proposed; that is, thermoplastic synthetic fibers each composed of a low-melting-point component and a high-melting-point component are knitted with a three-guide-reed tricot knitting machine, in which the ridge portions are formed from a thermoplastic synthetic fiber whose fineness is 1.2 times or more higher than that of the fiber forming the base structure, and such a knitted fabric is heat-treated and thus rigidified (PTL 1). However, because this flow path material uses a thin-fineness thermoplastic synthetic fiber and a thick-fineness thermoplastic synthetic fiber using three guide reeds, there have been problems of low productivity and high cost. In addition, there has also been a problem in that the thickness of the flow path material cannot be reduced.

In order to solve the problems of PTL 1, a technique for creating a back half structure using a tricot knitted fabric made of core-sheath composite fibers using two guide reeds (PTL 2) and a technique in which a tricot knitted fabric made of core-sheath composite fibers having a total fineness of 30 to 90 dtex is provided with a wale density of 35 to 45 yarns/inch (2.54 cm) and a course density of 35 to 55 yarns/inch (2.54 cm) (PTL 3) have been proposed.

In addition, because the osmotic pressure of seawater (sodium chloride concentration: 3.5 mass %) is 2.8 MPa, in desalination by reverse osmosis, in consideration of an increase in the salt concentration through the cross-flow method, a pressure of at least 4 to 6 MPa needs be applied inside the spiral-type element. In that case, there is a concern that the support coated with the membrane may collapse, or the flow path material for permeated water may collapse due to pressurization for a long period of time, resulting in a reduction of the flow rate.

### CITATION LIST

### Patent Literature

PTL 1: JPH3-66008B
PTL 2: JP3559475B
PLT 3: WO2017/131031

### SUMMARY OF INVENTION

### Technical Problem

However, both PTLs 2 and 3 are disadvantageous in that when the fabric is used as a flow path material for high-pressure operation, the flow path is blocked due to the pressure, leading to an insufficient flow rate.

In addition, in all of the above three prior art references, it is described that thermoplastic core-sheath composite fibers are knitted into a single tricot structure, followed by heat-setting, thereby hardening the entire tricot fabric; as a result, even through reverse osmosis pressurization, which is required for seawater desalination, the flow path is not blocked, causing no reduction of the flow rate. However, none of them have made any comparison or study regarding the maintenance of the cross-sectional area of a flow path under actual reverse osmosis.

That is, the proneness to collapse of a flow path material during pressurization has not been studied. In addition, although there is a method for inspecting the thickness of a flow path material after pressurization at room temperature, it requires pressurization for a long time. In the case where multiple inspections are performed, considerable effort and cost are required.

In addition, in the case where the proneness to collapse is inspected at room temperature, because the material used for a flow path material is made of a thermoplastic polymer and exhibits a returning behavior to its original state when pressurization is stopped, it has been difficult to verify its proneness to collapse.

Therefore, it has not been possible to easily find a configuration and conditions for a flow path material, where the flow path material is most unlikely to collapse upon the application of a high pressure thereto and causes a lower reduction of the flow rate.

The invention has been accomplished to solve the above problems, and an object thereof is to provide a flow path material for a liquid separation apparatus, which is less likely to collapse upon the application of a high pressure to the flow path material and causes a lower reduction of the flow rate.

### Solution to Problems

Until now, there has been no comparison or study made regarding the maintenance of the cross-sectional area of a flow path under conditions equivalent to actual reverse osmosis and the flow rate at that time.

The present inventor has found a method for easily determining the degree of collapse of a flow path material when pressurized with a high pressure for a long period of time. That is, with respect to the resins constituting a flow path material for permeated water, by measuring the thickness of the flow path material after pressurizing the resins at a temperature equal to or higher than the glass transition temperature and the thickness of the flow path material before pressurization, the proneness to collapse can be easily measured. Further, using this method, he has found a configuration and conditions for a flow path material, where the flow path material is most unlikely to collapse upon the application of a high pressure thereto and causes a lower reduction of the flow rate, and thus arrived at the invention.

That is, an object of the invention is achieved by a flow path material for a liquid separation apparatus, including a tricot fabric containing thermoplastic core-sheath composite fibers each made of two kinds of polyester resins having different melting points or softening points. The flow path material for a liquid separation apparatus is configured such that in the thermoplastic core-sheath composite fibers, a high-melting-point component is placed in the core, while a low-melting-point component is placed in the sheath; the tricot fabric is a tricot knitted fabric knitted using the thermoplastic core-sheath composite fibers as a front yarn and a back yarn in a two-guide-reed knitting machine; the tricot fabric is rigidified by the thermoplastic core-sheath composite fibers being bonded to each other; the tricot fabric has a wale density of 45 to 70 yarns/inch (2.54 cm) and a course density of 40 to 70 yarns/inch (2.54 cm); and, when the tricot fabric is heat-pressed at 90° C. and 4.0 MPa for 3 minutes, the percentage of change in the thickness of the tricot fabric before and after pressing is 10% or less.

In addition, it is preferable that the total fineness of the front-yam and back-yarn thermoplastic core-sheath composite fibers constituting the tricot fabric is 110 to 200 dtex, the difference in runner length between the front yarn and the back yarn is 5 cm or less, and the thickness of the tricot fabric is 0.2 to 0.3 mm.

In addition, it is preferable that the tricot fabric is configured such that one of two guide reeds forms base structure (back yarn) portions which are sinker loop parts, while the other guide reed forms convex portions (front yarn) which are needle loop parts, and the ratio of the width between convex portions (groove width) to the convex portion width (ridge width) (groove width/ridge width) is 0.4 to 0.7.

In addition, it is preferable that in the thermoplastic core-sheath composite fibers constituting the tricot, the difference in total fineness between the convex portions (front yarn) and the base structure portions (back yarn) is 20 dtex or more.

### Advantageous Effects of Invention

The flow path material for a liquid separation apparatus of the invention is a flow path material for a liquid separation apparatus, which has high compression resistance and is less likely to collapse upon the application of a high pressure to the flow path material, and causes a lower reduction of the flow rate.

### DESCRIPTION OF EMBODIMENTS

The flow path material for a liquid separation apparatus of the invention includes a tricot fabric containing thermoplastic core-sheath composite fibers each made of two kinds of polyester resins having different melting points or softening points.

In the thermoplastic core-sheath composite fibers, a high-melting-point component is placed in the core, while a low-melting-point component is placed in the sheath. The melting point difference between the two components is preferably 60° C. or more. Incidentally, in the invention, in the case where a component has no melting point and has a softening point, a difference from the softening point is also referred to as “melting point difference”.

As a polyester preferable as the low-melting-point component, a copolymerized ester containing terephthalic acid and ethylene glycol as main components and also containing, as a copolymerization component, a predetermined proportion of a combination of, as an acid component, an aliphatic dicarboxylic acid such as oxalic acid, malonic acid, azelaic acid, adipic acid, or sebacic acid, an aromatic dicarboxylic acid such as phthalic acid, isophthalic acid, or naphthalene dicarboxylic acid, and/or an alicyclic dicarboxylic acid such as hexahydroterephthalic acid, and one or more glycols of aliphatic, alicyclic, and aromatic diols such as diethyl glycol, polyethylene glycol, propylene glycol, hexanediol, paraxylene glycol, and bishydroxyethoxyphenyl propane, which optionally has an oxyacid such as parahydroxybenzoic acid added in a proportion of 50 mol % or less, is favorable.

Among those described above, a polyester obtained by adding isophthalic acid to terephthalic acid and ethylene glycol, followed by copolymerization, is particularly favorable. Then, among such isophthalic acid copolymerized polyesters, one having an isophthalic acid component copolymerized at 10 to 30 mol % is preferable from the viewpoint of ease of fusion fixing and knittability. Incidentally, the softening point may be adjusted as desired by changing the copolymerization ratio of the above component monomers.

As the high-melting-point component, homopolyesters such as polyethylene terephthalate, polybutylene terephthalate, and polytriethylene terephthalate can be mentioned.

In the invention, a core-sheath type composite polyester multifilament using an isophthalic acid copolymerized polyester as the low-melting-point component in the sheath and a homopolyester as the high-melting-point component in the core is optimal. In addition, together with isophthalic acid, straight-chain fatty acid diols such as 1,4-butanediol, 1,6-hexanediol, and 1,9-nonanediol may also be used. Incidentally, the core/sheath ratio is, on a volume basis, preferably set at 5/1 to 1/5, and particularly preferably set at 3/1 to 1/2.

In the core-sheath type composite multifilament, it is preferable that the fineness is 44 to 110 dtex, the number of yarns is 18 to 36, and the single-yarn fineness is 1.2 to 6.2 dtex. When the fineness is less than 44 dtex, the yarn is so thin that when a pressure is applied from above loops, the fabric cannot withstand the pressure and collapses easily. Meanwhile, when the total fineness is more than 110 dtex, the fabric thickness increases, and the resulting fabric tends to be hard and unsuitable as a flow path material for permeated water.

The tricot fabric in the invention is a tricot knitted fabric knitted using the thermoplastic core-sheath composite fibers as a front yarn and a back yarn in a two-guide-reed knitting machine and is rigidified by bonding the thermoplastic core-sheath composite fibers to each other.

The thermoplastic core-sheath composite fibers used as a front yarn and a back yarn may be fibers having the same core-sheath component composition or may also be fibers having different compositions, but it is favorable that they have the same melting point or softening point.

It is preferable that the tricot fabric has a wale density of 45 to 70 yarns/inch (2.54 cm) and a course density of 40 to 70 yarns/inch (2.54 cm).

In the case where the wale density is 45 yarns/inch (2.54 cm) or more, and the course density is 40 yarns/inch (2.54 cm) or more, there are a large number of needle loop convex portions in a certain area. Thus, when a pressure is applied from above loops, the fabric withstands the pressure and tends not to collapse easily. In addition, in the case where the wale density is 70 yarns/inch or less, and the course density is 70 yarns/inch or less, the fabric thick does not increase, and the resulting fabric is unlikely to be hard and is suitable as a flow path material for permeated water.

In addition, the product of the wale density and course density of the tricot fabric is preferably 2,700 or more, and more preferably 3,000 or more.

When the product of the wale density and course density of the tricot fabric is less than 2700, the number of needle loop convex portions in a certain area is small. Thus, when a pressure is applied from above loops, the fabric tends to be unable to withstand the pressure and collapses easily.

In addition, the product of the wale density and course density of the tricot fabric is preferably 4,900 or less.

In the case where the product of the wale density and course density of the tricot fabric is more than 4,900, the fabric thickness increases, and the resulting fabric tends to be hard and unsuitable as a flow path material for permeated water.

As the knitting structure of the tricot fabric, single tricot stitches such as a double denbigh structure, a back half structure, and a half tricot structure can be mentioned, and, among them, a double denbigh structure is preferable.

In the case of a double tricot stitch, the fabric thickness increases, and the resulting fabric tends to be hard and unsuitable as a flow path material for permeated water.

In addition, the total fineness of the front-yarn and back-yarn thermoplastic core-sheath composite fibers constituting the tricot fabric is preferably 110 to 200 dtex.

When the total fineness of the front-yarn and back-yam thermoplastic core-sheath composite fibers constituting the tricot fabric is less than 110 dtex, the strength of the needle loop convex portions decreases. Thus, when a pressure is applied from above loops, the fabric tends to be unable to withstand the pressure and collapses easily. In addition, when the total fineness of the front-yam and back-yam thermoplastic core-sheath composite fibers constituting the tricot fabric is more than 200 dtex, the fabric thickness increases, and the resulting fabric tends to be hard and unsuitable as a flow path material for permeated water.

The difference in runner length between the front yarn and back yarn of the tricot fabric is preferably 5 cm or less.

When the difference in runner length between the front yarn and back yarn of the tricot fabric is more than 5 cm, the balance between the base structure portions, which are sinker loop parts, and the convex portions, which are needle loop parts, is deteriorated. As a result, the tricot fabric may tear during a heat-setting treatment, or it may not be possible to adjust the performance as desired.

In addition, the thickness of the tricot fabric is preferably 0.2 to 0.3 mm.

When the thickness of the tricot fabric is less than 0.2 mm, the void space formed by the base structure portions, which are sinker loop parts, and convex portions, which are needle loop parts, of the tricot flow path material is reduced, making it impossible to secure a sufficient flow rate. When the thickness of the tricot fabric is more than 0.3 mm, the fabric thickness increases, and the resulting fabric tends to be hard and unsuitable as a flow path material for permeated water.

In the thermoplastic core-sheath composite fibers constituting the tricot fabric, the difference in total fineness between the front yarn and the back yarn is preferably 20 dtex or more.

When the difference in total fineness between the front yarn and the back yarn is less than 20 dtex, the strength of the needle loop convex portions and the strength of the base structure of the sinker loop parts decrease. Thus, when a pressure is applied from above loops, the fabric cannot withstand the pressure and collapses easily.

In addition, the difference in total fineness between the front yarn and the back yarn is preferably 70 dtex or less.

Incidentally, either of the total fineness of the front yarn and the total fineness of the back yarn may be larger than the other.

It is necessary that when the tricot fabric is heat-pressed at 90° C. and 4.0 MPa for 3 minutes, the percentage of change in the thickness of the tricot fabric before pressure application and after pressure application is 10% or less.

The fact that when the tricot fabric is heat-pressed at 90° C. and 4.0 MPa for 3 minutes, the percentage of change in the thickness of the tricot fabric before pressure application and after pressure application is more than 10% shows that the strength of the needle loop convex portions is low. Thus, when a pressure is applied from above loops, the fabric cannot withstand the pressure and collapses easily.

In addition, it is preferable that when the tricot fabric is hot-pressed at 90° C. and 4.0 MPa for 3 minutes, the percentage of change in the thickness of the tricot fabric before pressure application and after pressure application is 6% or less.

In addition, with respect to the resins constituting the flow path material for permeated water, when a pressure is applied to the resins while being subjected to a temperature equal to or higher than the glass transition temperature, the distortion caused by the pressure can be fixed; utilizing this, by measuring the thickness of the flow path material after pressurization and that of the flow path material before pressurization, the proneness to collapse can be easily measured. In the invention, polyester-based resins are used, and, because the glass transition point of a polyester-based resin is about 80° C., heat pressing is performed at 90° C.

The tricot fabric in the invention uses two guide reeds, one of which forms the base structure portions, which are sinker loop parts, and the other guide reed forms the convex portions, which are needle loop parts, and it is preferable that the ratio of the width between convex portions (groove width) to the convex portion width (ridge width)(groove width/ridge width) is 0.4 to 0.7. At that time, the groove width is preferably 100 to 200 μm, and the ridge width is preferably 150 to 350 μm.

When the ratio of the width between convex portions (groove width) to the convex portion width (ridge width) (groove width/ridge width) in needle loops is less than 0.4, the void space formed by the base structure portions, which are sinker loop parts, and convex portions, which are needle loop parts, of the tricot flow path material is reduced, making it impossible to secure a sufficient flow rate. When the ratio of the width between convex portions (groove width) to the convex portion width (ridge width) (groove width/ridge width) in needle loops is more than 0.7, the strength of the needle loop convex portions decreases. Thus, when a pressure is applied from above loops, the fabric cannot withstand the pressure and collapses easily.

The width between the convex portions (groove width) and the the convex portion width (ridge width) in needle loops described above may be adjusted with the knitting density, the total fineness of the thermoplastic core-sheath composite fibers used, and the heat-setting conditions to make the widths and their ratio as desired.

The tricot fabric according to the invention is produced, for example, by the following method.

A tricot knitted fabric is knitted using thermoplastic core-sheath composite fibers as a front yarn and a back yarn in a two-guide-reed tricot knitting machine. The obtained tricot knitted fabric is heat-set and rigidified by bonding the thermoplastic core-sheath composite fibers to each other, thereby giving a tricot fabric. The gauge number of the tricot knitted fabric is preferably 28 or more.

In addition, heat setting may be performed using a pin tenter heat treatment machine, a cylinder dryer, or the like.

The above tricot fabric can be favorably used as a permeate-side flow path material in a liquid separation apparatus. The flow path material for a liquid separation apparatus of the invention does not collapse even when pressurized with a high pressure of 4 to 6 MPa for a long period of time and causes a lower reduction of the flow rate.

### EXAMPLES

Hereinafter, the invention will be described in detail with reference to examples, but the invention is not necessarily limited thereto. Incidentally, the methods for measuring various characteristics and the tricot fabric evaluation criteria used in the examples are as follows.

### (1) Percentage of Change (%) in Thickness of Tricot Fabric Before/after Heat Pressing

Using a tabletop hot press (manufactured by Techno Supply Corp., Small Press, Model G-12), a tricot fabric was hot-pressed at 90° C. and 4.0 MPa for 3 minutes. The thickness of the tricot fabric before pressurization and after pressurization at this time was measured, and the percentage of change in thickness was calculated using the following formula.

$$Percentage of change in thickness ( \% ) = \{ ( thickess before pressurization - thickness after pressurization ) / thickness before pressurization \} \times 100$$

### (2) Groove Width (μm) and Ridge Width (μm) of Tricot Fabric

Planar and cross-sectional photographs of a tricot fabric were taken using an optical microscope, and the groove width and the ridge width were measured.

### (3) Thickness of Tricot Fabric (Mm)

The thickness of a tricot fabric was measured using a PEACOCK dial gauge (manufactured by Ozaki Mfg. Co., Ltd., Model H-30, 0.01 scale, gauge head: 30 mmφ).

(4) Density (Yarns/Inch (2.54 cm))

The number of courses and the number of wells in a 1-inch (2.54 cm) section of a tricot fabric were measured in accordance with JIS L 1096 8.6.2, Density of Knitted Fabric.

### (5) Rate of Flow Rate Reduction

A liquid separation membrane having a 50-μm-thick cellulose acetate porous membrane formed on a wet-laid polyester nonwoven fabric having a thickness of 100 μm and a density of 0.8 g/cm² was prepared. At the same time, a polypropylene net having a thickness of 700 μm was prepared as a flow path material for raw water. Then, the flow path forming material formed of a tricot fabric was placed on the permeation surface of the liquid separation membrane, while the flow path material for raw water was placed on the raw water side, creating a spiral-type liquid separation membrane module. Then, using the liquid separation membrane module, raw water (NaCl aqueous solution with a concentration of 3.5 wt %) was actually supplied at a pressure of 5 Mpa and subjected to an operation to achieve a salt removal rate of 99.5% or more. After 240-hour use, the rate of the permeated water flow rate reduction was measured.

### Example 1

Using polyethylene terephthalate (melting point: 260° C.) as a core, and a low-melting-point copolymerized polyester (melting point: 190° C.) obtained by copolymerizing 25% mol % of isophthalic acid as the acid component of polyethylene terephthalate as a sheath, where the core/sheath ratio at that time was 7/3 on a volume basis, a thermoplastic core-sheath composite fiber A (84 dtex/24 f) was obtained. Using the above composite fiber as a front yarn and a thermoplastic core-sheath composite fiber B with the same resin combination (56 dtex/24 f) as a back yarn, the yarns were knitted into a double denbigh structure (closed stitch) using a 36-gauge two-guide-reed tricot knitting machine.

The obtained tricot knitted fabric was heat-set for 1 minute with a pin tenter set at 200° C., thereby giving a tricot fabric flow path material having a wale density of 50 yarns/inch (2.54 cm) and a course density of 60 yarns/inch (2.54 cm). In addition, the percentage of change (%) in the thickness of the obtained tricot fabric before and after heat pressing was 5.6%.

### Example 2

A flow path material was obtained in the same manner as in Example 1, except that the wale density and course density of the processed fabric after being heat-set for 1 minute with a pin tenter were 70 yarns/inch (2.54 cm) and 45 yarns/inch (2.54 cm), respectively.

The percentage of change (%) in the thickness of the obtained tricot fabric before and after heat pressing was 5.7%.

### Example 3

A flow path material was obtained in the same manner as in Example 1, except that the gauge number of the tricot knitting machine was 28, and the wale density and course density of the processed fabric after being heat-set for 1 minute with a pin tenter were 45 yarns/inch (2.54 cm) and 70 yarns/inch (2.54 cm), respectively.

The percentage of change (%) in the thickness of the obtained tricot fabric before and after heat pressing was 8.5%.

### Example 4

A flow path material was obtained in the same manner as in Example 1, except that the knitting structure was a half tricot structure.

The percentage of change (%) in the thickness of the obtained tricot fabric before and after heat pressing was 8.7%.

### Example 5

A flow path material was obtained in the same manner as in Example 1, except that the knitting structure was a back half structure.

The percentage of change (%) in the thickness of the obtained tricot fabric before and after heat pressing was 7.1%.

### Comparative Example 1

A flow path material was obtained in the same manner as in Example 1, except that the wale density and course density of the processed fabric after being heat-set for 1 minute with a pin tenter were 75 yarns/inch (2.54 cm) and 35 yarns/inch (2.54 cm), respectively.

When the obtained tricot fabric was heat-pressed, the percentage of change in thickness (%) before and after the treatment was 10.6%.

### Comparative Example 2

A flow path material was obtained in the same manner as in Example 1, except that the wale density and course density of the processed fabric after being heat-set for 1 minute with a pin tenter were 35 yarns/inch (2.54 cm) and 75 yarns/inch (2.54 cm), respectively.

When the obtained tricot fabric was heat-pressed, the percentage of change in thickness (%) before and after the treatment was 13.1%.

TABLE 1

| | | | | Tricot Fabric | | | | Tricot Fabric Physical Properties | |
|---|---|---|---|---|---|---|---|---|---|
| | Synthetic Fiber | | | | Runner | | | | Groove |
| | Guide | | | | Length | Density | | | Width |
| | Reed | Fineness | | | Difference | Wale | Course | Thickness | (a) |
| | Position | (dtex) | (dtex) | Structure | cm | (yarns/inch) | (yarns/inch) | (mm) | (μm) |
| Example 1 | Front yarn | 84 | 140 | Double | 3.0 | 50 | 60 | 0.25 | 165 |
| | Back yarn | 56 | | denbigh | | | | | |
| Example 2 | Front yarn | 84 | 140 | Double | 4.0 | 70 | 45 | 0.22 | 140 |
| | Back yarn | 56 | | denbigh | | | | | |
| Example 3 | Front yarn | 84 | 140 | Double | 4.0 | 45 | 70 | 0.21 | 190 |
| | Back yarn | 56 | | denbigh | | | | | |
| Example 4 | Front yarn | 84 | 140 | Half tricot | 3.0 | 50 | 60 | 0.24 | 160 |
| | Back yarn | 56 | | | | | | | |
| Example 5 | Front yarn | 56 | 140 | Back half | 3.0 | 50 | 60 | 0.25 | 160 |
| | Back yarn | 84 | | tricot | | | | | |
| Comparative | Front yarn | 84 | 140 | Double | 4.0 | 75 | 35 | 0.21 | 130 |
| Example 1 | Back yarn | 56 | | denbigh | | | | | |
| Comparative | Front yarn | 84 | 140 | Double | 4.0 | 35 | 75 | 0.20 | 200 |
| Example 2 | Back yarn | 56 | | denbigh | | | | | |

| | Tricot Fabric Physical Properties | | | | | | |
|---|---|---|---|---|---|---|---|
| | Ridge | | | Thickness | Pressurization | Percentage of | Rate of |
| | Width | | Density | before | Thickness | Change in | Flow Rate |
| | (b) | (a)/(b) | Product | Pressurization | after | Thickness | Reduction |
| | (μm) | — | — | (mm) | (mm) | (%) | (%) |
| Example 1 | 330 | 0.50 | 3000 | 0.250 | 0.236 | 5.6 | 3.5 |
| Example 2 | 340 | 0.41 | 3150 | 0.211 | 0.199 | 5.7 | 3.8 |
| Example 3 | 270 | 0.70 | 3150 | 0.200 | 0.183 | 8.5 | 5.0 |
| Example 4 | 320 | 0.50 | 3000 | 0.254 | 0.232 | 8.7 | 5.0 |
| Example 5 | 330 | 0.48 | 3000 | 0.253 | 0.235 | 7.1 | 5.0 |
| Comparative | 310 | 0.42 | 2625 | 0.209 | 0.187 | 10.6 | 8.0 |
| Example 1 | | | | | | | |
| Comparative | 285 | 0.70 | 2625 | 0.198 | 0.172 | 13.1 | 9.0 |
| Example 2 | | | | | | | |

### Result

### Examples 1 to 5

When the tricot fabrics were heat-pressed, the percentage of change in thickness (%) before and after the treatment was less than 10.0%, and the rate of the flow rate reduction at that time was less than 5%. When evaluated as a flow path material, these fabrics were at such a level that stable use was possible for a long period of time.

### Comparative Example 1 and 2

When the tricot fabrics were heat-pressed, the percentage of change in thickness (%) before and after the treatment was more than 10%. In addition, the rate of the flow rate reduction at that time was more than 5%. When evaluated as a flow path material, due to the low flow rate, these fabrics were unable to withstand actual use.

1. A flow path material for a liquid separation apparatus, comprising a tricot fabric containing thermoplastic core-sheath composite fibers each made of two kinds of polyester resins having different melting points or softening points,
the flow path material for a liquid separation apparatus being configured such that:
in the thermoplastic core-sheath composite fibers, a high-melting-point component is placed in the core, while a low-melting-point component is placed in the sheath;
the tricot fabric is a tricot knitted fabric knitted with a two-guide-reed knitting machine using the thermoplastic core-sheath composite fibers as a front yarn and a back yarn and is rigidified by the thermoplastic core-sheath composite fibers being bonded to each other;
the tricot fabric has a wale density of 45 to 70 yarns/inch (2.54 cm) and a course density of 40 to 70 yarns/inch (2.54 cm); and,
when the tricot fabric is heat-pressed at 90° C. and 4.0 MPa for 3 minutes, the percentage of change in the thickness of the tricot fabric before and after pressing is 10% or less.

2. The flow path material for a liquid separation apparatus according to claim 1, wherein the total fineness of the front-yarn thermoplastic core-sheath composite fiber and back-yarn thermoplastic core-sheath composite fiber constituting the tricot fabric is 110 to 200 dtex, the difference in runner length between the front yarn and the back yarn is 5 cm or less, and the thickness of the tricot fabric is 0.2 to 0.3 mm.

3. The flow path material for a liquid separation apparatus according to claim 1, wherein
the tricot fabric is configured such that one of two guide reeds forms base structure portions which are sinker loop parts, while the other guide reed forms convex portions which are needle loop parts, and
the ratio of the width between convex portions (groove width) to the convex portion width (ridge width) (groove width/ridge width) is 0.4 to 0.7.

4. The flow path material for a liquid separation apparatus according to claim 1, wherein the difference in total fineness between the front-yarn thermoplastic core-sheath composite fiber and back-yarn thermoplastic core-sheath composite fiber constituting the tricot fabric is 20 dtex or more.
